(19) United States
(12) Patent Application Publication
(10) Pub. No.: US 2026/0183176 A1
(43) Pub. Date: Jul. 2, 2026

(54) HAND MASSAGING APPARATUS AND HAND MASSAGING MECHANISM THEREOF

(71) Applicants: Xiamen Comfort Science & Technology, Xiamen (CN); Zhangzhou Easepal Industrial Co., Ltd, Zhangzhou (CN)

(72) Inventors: Weijie CHEN, Zhangzhou (CN); Guouyn Tang, Zhangzhou (CN)

(21) Appl. No.: 19/190,878

(22) Filed: Apr. 28, 2025

(30) Foreign Application Priority Data
Dec. 27, 2024 (CN) 202423258328.1

(51) Int. Cl. A61H 7/00; A61H 9/00

(52) U.S. Cl. CPC A61H 7/007; A61H 7/004; A61H 9/0078; A61H 2007/009; A61H 2201/0103; A61H 2201/1246; A61H 2201/1635; A61H 2201/165; A61H 2201/1669; A61H 2201/5056; A61H 2205/065; A61H 2205/067

(57) ABSTRACT

A hand massaging mechanism includes a moving frame, a plurality of airbag finger sleeves disposed on the moving frame and configured to be respectively sleeved on human fingers to be inflated to expand, a driving device connected to the moving frame and configured to drive the moving frame to move, and an inflation assembly. The inflation assembly includes an air pump and a plurality of first air valves, and the air pump is connected to each of the plurality of first air valves through pipelines. The plurality of first air valves are respectively connected to the plurality of airbag finger sleeves through the pipelines to control inflation and deflation of each of the plurality of airbag finger sleeves.

### RELATED APPLICATIONS

This application claims priority to Chinese patent application number 202423258328.1, filed on Dec. 27, 2024. Chinese patent application number 202423258328.1 is incorporated herein by reference.

### FIELD OF THE DISCLOSURE

The present application relates to the technical field of massaging equipment and in particular relates to a hand massaging apparatus and a hand massaging mechanism thereof which are specially used for massaging human hands.

### BACKGROUND OF THE DISCLOSURE

With the improvement in living standards, demand by people for physical health and wellness has gradually increased. As an important wellness method, massage has gained growing attention and boasts a broad application market. The human palm contains numerous acupoints, and regular massages of these acupoints benefits both physical and mental health. Currently available specialized hand massage devices on the market have relatively simple functionalities, typically limited to compression features—such as mechanical pressing on specific areas of the hand. Traditional hand massagers suffer from monotonous massage techniques and poor user experience, failing to meet consumer needs and consequently affecting sales performance.

### BRIEF SUMMARY OF THE DISCLOSURE

The purpose of the embodiments of the present application is to provide a hand massaging apparatus and a hand massaging mechanism, in order to solve the technical problem in the existing techniques where existing hand massage devices only employ mechanical pressing techniques, resulting in limited massage methods.

In order to solve the above technical problems, the present disclosure provides a hand massaging mechanism. The hand massaging mechanism comprises a moving frame, a plurality of airbag finger sleeves disposed on the moving frame and configured to be respectively sleeved on human fingers to be inflated to expand, a driving device connected to the moving frame and configured to drive the moving frame to move, and an inflation assembly. The inflation assembly comprises an air pump and a plurality of first air valves, and the air pump is connected to each of the plurality of first air valves through pipelines. The plurality of first air valves are respectively connected to the plurality of airbag finger sleeves through the pipelines to control inflation and deflation of each of the plurality of airbag finger sleeves.

The beneficial effect of a hand massaging apparatus provided by the present application is that: compared with the existing techniques, the hand massaging mechanism of the present application has the moving frame and the plurality of airbag finger sleeves for respectively sleeving on the human fingers, and the plurality of airbag finger sleeves can completely wrap the human fingers. When the plurality of airbag finger sleeves are inflated, the plurality of airbag finger sleeves can give the human fingers a sense of squeezing, which is better than the traditional structure of clamping the fingers from two sides. The driving device is configured to drive the moving frame to drive each of the plurality of airbag finger sleeves to move synchronously, thereby forming a massage action similar to an action of kneading and stretching the human fingers in a direction of finger extension, effectively giving the human fingers a stretching massage feel. In the hand massaging mechanism provided in the embodiment of the present application, the inflation assembly comprises the air pump and the plurality of first air valves for respectively controlling inflation and deflation of each of the plurality of airbag finger sleeves. The plurality of first air valves are respectively connected to the plurality of airbag finger sleeves through the pipelines, so as to realize a stretching massage action on the human fingers individually or in any combination, effectively improving a massage simulation sense and improving the user experience.

An improvement is made to the structure on the moving frame. The moving frame comprises a plurality of fixation holes for receiving the plurality of airbag finger sleeves, and the plurality of fixation holes are arranged in a row on the moving frame. Air nozzles of the plurality of airbag finger sleeves are respectively exposed from the plurality of fixation holes on the moving frame and are respectively connected to the plurality of first air valves through the pipelines. The plurality of airbag finger sleeves can be fixed on the moving frame in a row according to positions of the plurality of fixation holes, so that the human fingers can be automatically aligned with the plurality of airbag finger sleeves when wearing.

In one embodiment, the hand massaging mechanism further comprises position-limiting frames corresponding to two sides of the moving frame. Each of the position-limiting frames has a travel groove. The two sides of the moving frame are respectively disposed with rollers configured to be disposed in the travel grooves and move in the travel grooves. In this way, when the driving device drives the moving frame to move, the moving frame moves in the travel grooves of the position-limiting frames using the rollers, thereby limiting a displacement direction and a movement range of the moving frame.

In one embodiment, the hand massaging mechanism further comprises a mounting base on which the driving device is disposed. The driving device is disposed on the mounting base, and an output end of the driving device is connected to the moving frame to drive the moving frame to move linearly.

In one embodiment, the mounting base further comprises one or more resetting mechanisms for driving the moving frame to automatically reset after displacement, and the mounting base comprises one or more sleeve lugs. Each of the one or more resetting mechanisms comprises a connecting shaft and an elastic member. A first end of the connecting shaft comprises a position-limiting cap, and a second end of the connecting shaft passes through a corresponding one of the one or more sleeve lugs and is fixedly connected to the moving frame. The elastic member is sleeved on the connecting shaft, and two ends of the elastic member are respectively connected to the corresponding one of the one or more sleeve lugs and the position-limiting cap. In this way, after the driving device drives the moving frame to move, an elastic recovery function of the elastic member enables the moving frame to automatically reset, thereby driving the moving frame to reciprocate, which is conducive to repeated stretching and massaging of the human fingers.

An improvement is made to the structure of the driving device. The driving device comprises a pushing airbag and a second air valve. The pushing airbag is configured to expand in a first direction after being inflated, and an expansion end of the pushing airbag is connected to the moving frame. The second air valve is connected to the pushing airbag and the air pump through the pipelines. Compared with a traditional motor drive structure, the driving device is lighter and occupies less space, which is convenient for installation on wearable devices.

Another improvement is made to the structure of the driving device. The driving device comprises a linear cylinder, and an output end of the linear cylinder is connected to the moving frame. The linear cylinder is configured to drive the moving frame to perform linear motion, which can also achieve the stretching massage action on the human fingers.

The present application further provides a hand massaging apparatus. The hand massaging apparatus comprises a core. The core comprises the hand massaging mechanism. The core comprises an upper shell and a lower shell configured to be assembled with each other, and a wearing channel in which a human hand is configured to be disposed is defined between the upper shell and the lower shell. The inflation assembly is disposed on the upper shell, and the moving frame and the driving device are adjacent to each other and are disposed on the lower shell. The plurality of airbag finger sleeves are disposed in the wearing channel and are configured to be respectively sleeved on the human fingers. In this way, a movable assembly comprising the moving frame and the driving device is separated from the inflation assembly, effectively avoiding mutual interference, thereby improving a utilization rate of an internal space of the core, and helping to reduce a volume of a whole machine.

In one embodiment, the upper shell is disposed with a first airbag located in the wearing channel, and the lower shell is disposed with a second airbag located in the wearing channel. The inflation assembly further comprises a third air valve and a fourth air valve, which are connected to the air pump through the pipelines. The third air valve is connected to the first airbag through the pipelines, and the fourth air valve is connected to the second airbag through the pipelines. The first airbag is configured to squeeze and massage a back of the human hand, and the second airbag is configured to squeeze and massage a palm of the human hand. The third air valve and the fourth air valve respectively control inflation and deflation of the first airbag and the second airbag so that the first airbag and the second airbag can be started separately according to usage requirements.

In one embodiment, thumb holes for a thumb of the human hand to pass through are respectively provided on two sides of the core, and the thumb holes on the two sides of the core are symmetrically arranged, so that a left hand and a right hand can be used, effectively improving versatility of the hand massaging apparatus.

The present application further provides a hand massaging apparatus, and the hand massaging apparatus comprises an outer housing, an inner housing, a moving frame, a plurality of airbag finger sleeves, a driving device, and an inflation assembly. The inner housing is fixed inside the outer housing, and a receiving space is defined between the outer housing and the inner housing. The moving frame is reciprocatably arranged on the inner housing, and the plurality of airbag finger sleeves are configured to be respectively sleeved on human fingers to be inflated to expand. The driving device is connected to the moving frame and is configured to drive the moving frame to move, and the inflation assembly comprises an air pump and a plurality of first air valves. The air pump is connected to each of the plurality of first air valves through pipelines, and the plurality of first air valves are respectively connected to the plurality of airbag finger sleeves through the pipelines to control inflation and deflation of each of the plurality of airbag finger sleeves. The inner housing comprises a through hole, and the moving frame is arranged adjacent to the through hole. The plurality of airbag finger sleeves are contained in the inner housing, and the plurality of airbag finger sleeves pass through the through hole and are fixedly connected to the moving frame. When the plurality of airbag finger sleeves are inflated, the inner housing is configured to confine expansion of the plurality of airbag finger sleeves to apply compressive massage on the human fingers.

The inner shell confines the expansion of the plurality of airbag finger sleeves and the first airbag. When the palm is squeezed by the first airbag, the palm is fixed to the inner shell. At the same time, the plurality of airbag finger sleeves expand to squeeze and massage the human fingers. The driving device drives the moving frame to drive the plurality of airbag finger sleeves to move forward and backward to stretch the human fingers, thereby improving a massage experience on the human fingers.

### BRIEF DESCRIPTION OF THE DRAWINGS

In order to more clearly illustrate the technical solutions in the embodiments of the present application, the drawings required for use in the embodiments or the description of the existing techniques will be briefly introduced below. Obviously, the drawings described below are only some embodiments of the present application. For ordinary technicians in this field, other drawings can be obtained based on these drawings without paying any creative labor.

FIG. 1 is a perspective view of a hand massaging apparatus provided in an embodiment of the present application.

FIG. 2 is a first exploded view of the hand massaging apparatus provided in an embodiment of the present application.

FIG. 3 is an exploded view of assembling a moving frame and a plurality of airbag finger sleeves provided in an embodiment of the present application.

FIG. 4 is a second exploded view of the hand massaging apparatus provided in an embodiment of the present application.

FIG. 5 is a first perspective view of a core of the hand massaging apparatus provided in an embodiment of the present application.

FIG. 6 is a second perspective view of the core of the hand massaging apparatus provided in an embodiment of the present application.

FIG. 7 is a first exploded view of the core of the hand massaging apparatus provided in an embodiment of the present application.

FIG. 8 is a top view of the hand massaging apparatus provided in an embodiment of the present application.

FIG. 9 is a third exploded view of the hand massaging apparatus provided in an embodiment of the present application.

FIG. 10 is a fourth exploded view of the hand massaging apparatus provided in an embodiment of the present application.

FIG. 11 is a third perspective view of the core of the hand massaging apparatus provided in an embodiment of the present application.

FIG. 12 is a second exploded view of the core of the hand massaging apparatus provided in an embodiment of the present application.

FIG. 13 is a third exploded view of the core of the hand massaging apparatus provided in an embodiment of the present application.

FIG. 14 is a perspective view of a driving device provided in an embodiment of the present application when inflated.

FIG. 15 is a perspective view of the driving device provided in an embodiment of the present application when it is deflated.

FIG. 16 is a fourth perspective view of the core of the hand massaging apparatus provided in an embodiment of the present application.

FIG. 17 is a schematic diagram of assembling of a moving frame and the plurality of airbag finger sleeves provided in an embodiment of the present application.

FIG. 18 is an exploded view of assembling a first airbag and the plurality of airbag finger sleeves provided in an embodiment of the present application.

The reference numerals in the figure are:
100—core; 101—wearing channel; 102—entrance;
1—moving frame; 11—fixation hole; 111—guiding platform; 12—position-limiting frame; 121—travel groove; 122—fixing lug; 13—roller; 13′—sliding block;
2—airbag finger sleeve; 21—connecting head;
3—driving device; 31—pushing airbag; 32—second air valve;
4—inflation assembly; 41—air pump; 42—first air valve; 43—third air valve; 44—fourth air valve;
5—mounting base; 50—reset mechanism; 51—sleeve lug; 52—connecting shaft; 521—position-limiting cap; 53—elastic member; 54—guiding rod; 55—spring; 56—passing through hole;
6—upper shell; 60—upper cover; 61—buckling socket; 611—groove; 62—mounting frame; 621—series connection pipe; 63—control board; 64—control unit; 65—first airbag; 66—first through hole;
7—lower shell; 70—lower cover; 71—receiving opening; 711—surrounding edge; 72—fixing rod; 73—power supply; 74—storage box; 741—heat dissipation hole; 75—second airbag; 76—second through hole;
8—thumb hole;
900—outer housing; 901—inner housing; 902—through hole.

### DETAILED DESCRIPTION OF THE EMBODIMENTS

To make the technical problems addressed, technical solutions, and beneficial effects of the present application clearer and more comprehensible, the following provides a further detailed description of the application in conjunction with the accompanying drawings and embodiments. It should be understood that the specific embodiments described herein are intended solely to explain the present application and should not be construed as limiting it.

It should be noted that when an element is referred to as being “fixed to” or “disposed on” another element, it may be directly on the other element or indirectly positioned thereon. When an element is described as being “connected to” another element, it may be directly connected or indirectly linked to the other element.

It should be understood that directional or positional relationships indicated by terms such as “length,” “width,” “upper,” “lower,” “front,” “rear,” “left,” “right,” “vertical,” “horizontal,” “top,” “bottom,” “inner,” and “outer” are based on the orientations or positional relationships shown in the accompanying drawings. These terms are used solely to facilitate the description of the application and simplify the explanation, and do not indicate or imply that the referenced device or component must have a specific orientation or be constructed and operated in a particular orientation. Therefore, such terms should not be construed as limiting the present application.

Furthermore, terms such as “first” and “second” are used for descriptive purposes only and should not be interpreted as indicating relative importance or implicitly specifying the quantity of technical features. Thus, features defined as “first” or “second” may explicitly or implicitly include one or more such features. In the description of the present application, “a plurality of” means two or more, unless explicitly stated otherwise.

Currently on the market, specialized hand massage devices have limited functionality, typically only capable of performing compression techniques such as mechanical pressing on specific areas (acupoints) of the hand. These devices employ rigid and monotonous massage methods, unable to replicate the finger-stretching techniques used by professional masseurs. The poor tactile experience fails to meet user demands, thereby affecting sales performance.

In response, the embodiments of this application provide a hand massaging apparatus and a hand massaging mechanism thereof. In addition to achieving acupressure techniques, the hand massaging mechanism is capable of performing stretching massages on human fingers. This effectively diversifies massage modalities, enhances the therapeutic experience, and addresses the technical limitations of traditional hand massage devices that rely solely on mechanical compression with monotonous techniques. A detailed description will now be provided.

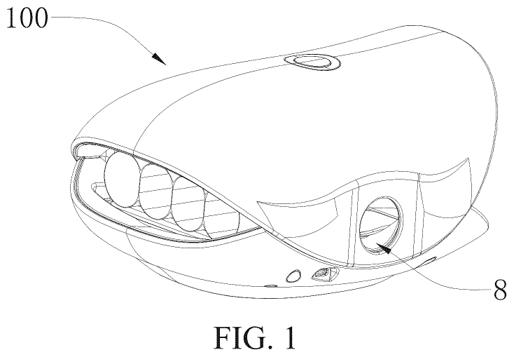

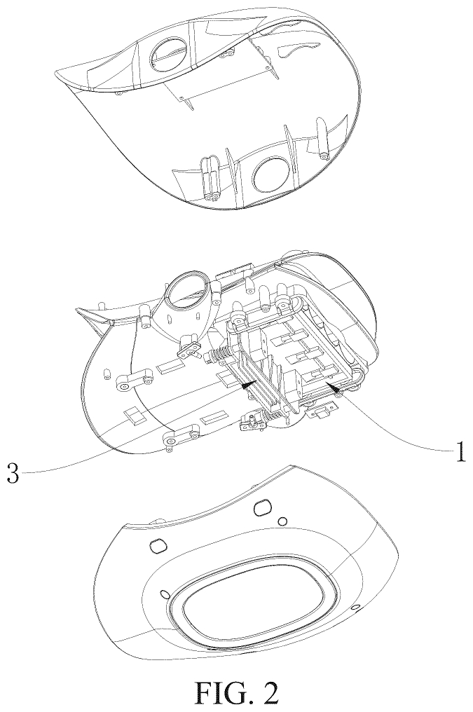

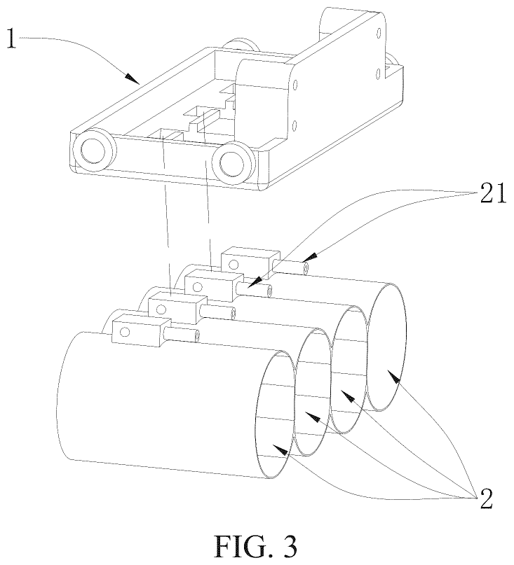

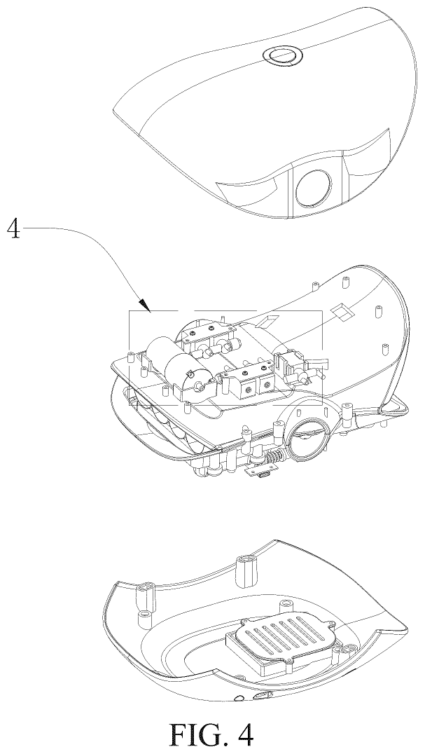

Referring to FIG. 1, the hand massaging apparatus comprises a core 100, and the core 100 comprises the hand massaging mechanism of the present application. Referring to FIG. 2, FIG. 3, and FIG. 4, the hand massaging mechanism at least comprises a moving frame 1, a plurality of airbag finger sleeves 2, a driving device 3, and an inflation assembly 4.

The plurality of airbag finger sleeves 2 are configured to be respectively sleeved on the human fingers on a palm of a person, and the plurality of airbag finger sleeves 2 are disposed on the moving frame 1. In this embodiment, as shown in FIG. 3, the plurality of airbag finger sleeves 2 are four airbag finger sleeves 2, which respectively correspond to an index finger, a middle finger, a ring finger, and a little finger of a human hand. In other embodiments (not shown in the figures), the plurality of airbag finger sleeves 2 can also be five airbag finger sleeves 2, which respectively correspond to five human fingers on the human hand. Compared with a traditional structure of clamping and pressing the human fingers from two sides, the plurality of airbag finger sleeves 2 of the present application are preferably sleeve structures, which are conducive to completely wrapping the human fingers, and provides a squeezing feeling to the human fingers after inflation, effectively enhancing tactile perception.

The driving device 3 is connected to the moving frame 1 and is configured to drive the moving frame 1 to drive each of the plurality of airbag finger sleeves 2 to move synchronously. In actual application, the plurality of airbag finger sleeves 2 brings a squeezing feeling to the human fingers after inflation. At the same time, the moving frame 1 drives the plurality of airbag finger sleeves 2 to move, thereby forming an action similar to an action of kneading and stretching the human fingers in a direction of a finger extension, effectively bringing a stretching massage feeling to the human fingers.

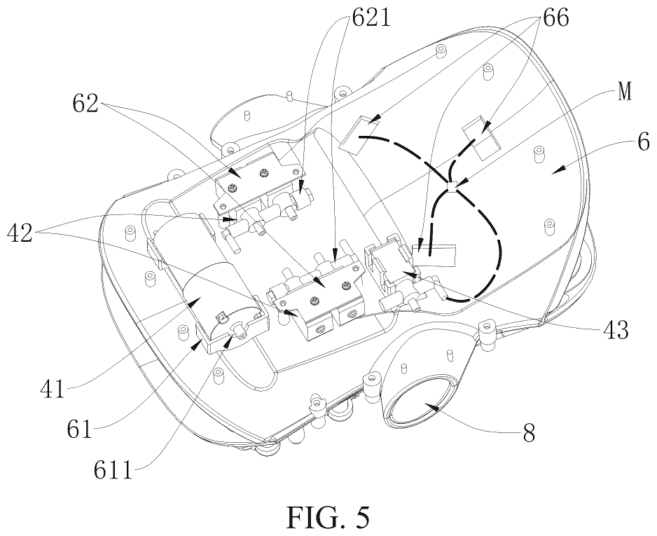

As for a mechanism for inflating the plurality of airbag finger sleeves 2 please refer to FIG. 5. The inflation assembly 4 comprises an air pump 41 and a plurality of first air valves 42, and a number of the plurality of first air valves 42 is the same as a number of the plurality of airbag finger sleeves 2. The air pump 41 is connected to each of the plurality of first air valves 42 through pipelines, and the plurality of first air valves 42 are respectively connected to the plurality of airbag finger sleeves 2 through the pipelines (not shown in the figures). The inflation assembly 4 is configured to control inflation and deflation of each of the plurality of airbag finger sleeves 2, so as to achieve a stretching massage action for each of the human fingers individually or in any combination.

Compared with the existing techniques, the hand massaging mechanism provided in the embodiment of the present application comprises the moving frame 1 and the plurality of airbag finger sleeves 2 respectively sleeved on the human fingers of the person. The plurality of airbag finger sleeves 2 can completely wrap the human fingers of the person. When the plurality of airbag finger sleeves 2 are inflated, the plurality of airbag finger sleeves 2 can give the human fingers a squeezing feeling, which is better than the traditional structure of clamping and pressing the human fingers from the two sides. The driving device 3 is configured to drive the moving frame 1 to drive each of the plurality of airbag finger sleeves 2 to move synchronously, thereby forming the action similar to the action of kneading and stretching the human fingers in the direction of the finger extension, effectively bringing the stretching massage feeling to the human fingers.

Compared with the massaging devices capable of finger stretching in the related art, the massaging devices of this type generally drive all fingers to stretch simultaneously, and cannot achieve stretching and massaging actions on an individual finger. In the hand massaging mechanism provided in the embodiment of the present application, the inflation assembly 4 comprises the air pump 41 and the plurality of first air valves 42, and the number of the plurality of first air valves 42 is the same as the number of the plurality of airbag finger sleeves 2. The plurality of first air valves 42 are connected to the air pump 41 and each of the plurality of airbag finger sleeves 2 through the pipelines. The inflation and the deflation of each of the plurality of airbag finger sleeves 2 can be controlled by a corresponding one of the plurality of first air valves 42, so as to achieve individual or any combination of stretching and massaging actions for each of the human fingers, effectively improving a massage simulation sense and improving the user experience.

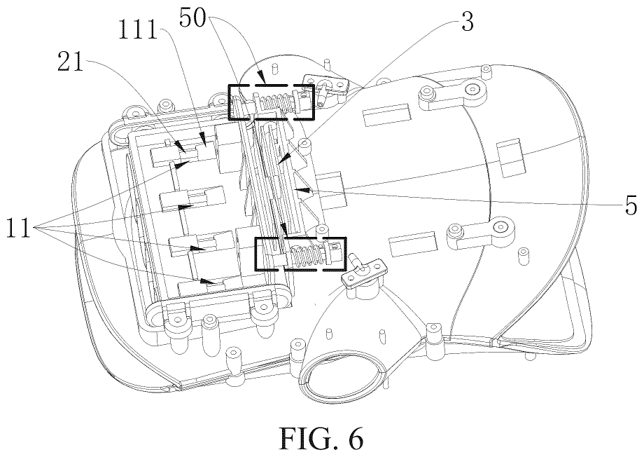

Regarding the structure of the moving frame 1, in one embodiment of the present application, referring to FIG. 3 and FIG. 6 together, the moving frame 1 comprises a plurality of fixation holes 11 for receiving the plurality of airbag finger sleeves 2, and the plurality of fixation holes 11 are arranged in a row on the moving frame 1. Air nozzles of the plurality of airbag finger sleeves 2 are respectively exposed from the plurality of fixation holes 11 on the moving frame 1, and the air nozzles of the plurality of airbag finger sleeves 2 are respectively connected to the plurality of first air valves 42 through the pipelines.

In this way, the plurality of airbag finger sleeves 2 can be fixed on the moving frame 1 in a row according to positions of the plurality of fixation holes 11, so that the human fingers can be automatically aligned with the plurality of airbag finger sleeves 2 when wearing, thereby improving the wearing experience.

In this embodiment, as shown in FIG. 3 and FIG. 6, the plurality of fixation holes 11 on the moving frame 1 are elongated holes, the air nozzle of the plurality of airbag finger sleeves 2 can be embedded in the plurality of fixation holes 11. Each of the air nozzles of the plurality of airbag finger sleeves 2 has a connecting head 21 configured to be connected to the pipelines. The connecting heads 21 of the plurality of airbag finger sleeves 2 have a same orientation in the plurality of fixation holes 11, so as to unify an orientation of the connecting heads 21 of the plurality of airbag finger sleeves 2 and facilitate installation and connection with the pipelines to be connected.

Preferably, as shown in FIG. 6, each of the plurality of fixation holes 11 of the moving frame 1 preferably comprises a guiding platform 111 inclined toward a corresponding one of the air nozzles, so that ends of the pipelines can slide along the guiding platforms 111 toward the connecting heads 21 to achieve an automatic alignment between the ends of the pipelines and the connecting heads 21, thereby improving installation efficiency.

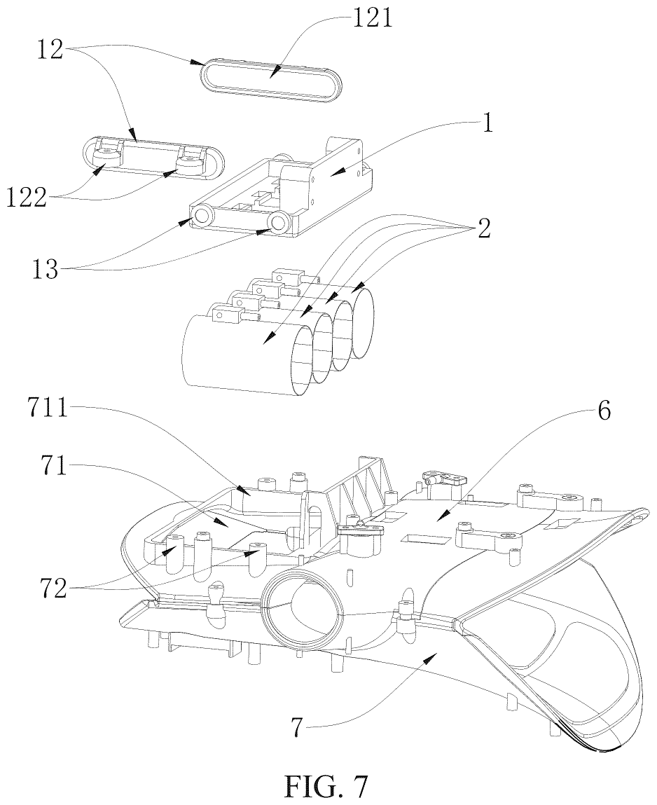

In one embodiment of the present application, referring to FIG. 7, the hand massaging mechanism further comprises position-limiting frames 12 corresponding to two sides of the moving frame 1, and each of the position-limiting frames 12 has a travel groove 121. The two sides of the moving frame 1 are respectively disposed with rollers 13, and the rollers 13 are configured to be installed in the travel grooves 121 and move in the travel grooves 121.

When the driving device 3 drives the moving frame 1 to move, a displacement direction and movement range of the moving frame 1 are limited by the roller 13 moving in the travel grooves 121 of the position-limiting frames 12, which is conducive to matching a length of the human fingers and maximizing the use of an internal space of the core 100 of the hand massaging apparatus.

In this embodiment, as shown in FIG. 7, each side of the moving frame 1 is disposed with two rollers 13 of the rollers 13. The two rollers 13 are preferably arranged on a same horizontal line and are respectively arranged adjacent to a front end and a rear end of the moving frame 1, so that the moving frame 1 can move smoothly in a straight direction.

The travel groove 121 of each of the position-limiting frames 12 is preferably a blind groove with a groove bottom surface to prevent the rollers 13 from being exposed from an outside of the position-limiting frames 12, and a groove depth of the travel grooves 121 is preferably able to accommodate the rollers 13 on the two sides of the moving frame 1. In this way, when the position-limiting frames 12 are installed to correspond to the two sides of the moving frame 1, the rollers 13 can be accommodated inside the position-limiting frames 12, thereby ensuring sealing, preventing foreign objects such as dust particles from entering and affecting movement of the rollers 13, and effectively ensuring smooth movement of the rollers 13. Fixing lugs 122 are preferably disposed on the outside of the position-limiting frames 12 so that the position-limiting frames 12 can be fixed in the core 100 of the hand massaging apparatus.

In one embodiment of the present application, referring to FIG. 6 and together, the hand massaging mechanism of the present application further comprises a mounting base 5 on which the driving device 3 is installed. The driving device 3 is disposed on the mounting base 5. An output end of the driving device 3 is connected to the moving frame 1 to drive the moving frame 1 to move linearly.

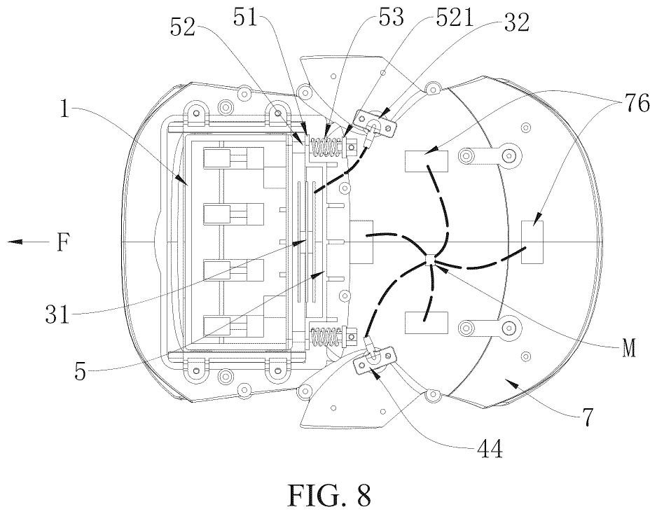

On the basis of the above structure, the mounting base 5 further comprises one or more resetting mechanisms 50 for driving the moving frame 1 to automatically reset after displacement. Referring to FIG. 8, the mounting base 5 comprises one or more sleeve lugs 51, and each of the one or more resetting mechanisms 50 comprises a connecting shaft 52 and an elastic member 53. A first end of the connecting shaft 52 comprises a position-limiting cap 521, and a second end of the connecting shaft 52 passes through a corresponding one of the one or more sleeve lugs 51 and is fixedly connected to the moving frame 1.

In this embodiment, the one or more resetting mechanisms 50 are two resetting mechanisms 50 disposed on two sides of the mounting base 5, and the one or more sleeve lugs 51 can preferably be a ring body integrally connected to the two sides of the mounting base 5, allowing the connecting shaft 52 to pass through and be fixedly connected to the moving frame 1.

The elastic member 53 can preferably be a spring. The elastic member 53 is sleeved on the connecting shaft 52. Two ends of the elastic member 53 are respectively connected to the corresponding one of the one or more sleeve lugs 51 and the position-limiting cap 521.

In this way, the driving device 3 on the mounting base 5 can drive the moving frame 1 to push the moving frame 1 outward, and after a driving force of the driving device 3 disappears, an elastic recovery function of the elastic member 53 is configured to automatically reset the moving frame 1, thereby driving the moving frame 1 to move back and forth, which is beneficial to repeated stretching and massaging actions on the human fingers.

A structure of the driving device 3 comprises but is not limited to the following forms.

In the embodiment of the present application, referring to FIG. 8, the driving device 3 comprises a pushing airbag 31 and a second air valve 32. The pushing airbag 31 is configured to expand in a first direction F after being inflated, and an expansion end of the pushing airbag 31 is connected to the moving frame 1. The “first direction F” here can be understood as an extension direction of the expansion end of the pushing airbag 31 after being inflated, and the extension direction matches the extension direction of the human fingers.

As a result, as the pushing airbag 31 is inflated to expand gradually in the first direction F, the moving frame 1 is driven to drive each of the plurality of airbag finger sleeves 2 to move toward the extension direction of the human fingers, thereby achieving a stretching massage action on the human fingers.

Preferably, the pushing airbag 31 is an accordion-like airbag that can expand and stretch in a set direction to effectively limit a moving direction of the moving frame 1.

The second air valve 32 is connected to the pushing airbag 31 and the air pump 41 through the pipelines, so as to control the pushing airbag 31 individually or in any combination, such as a single airbag finger sleeve 2 of the plurality of airbag finger sleeves 2, or any combination of two or three airbag finger sleeves 2 of the plurality of airbag finger sleeves 2.

It can be seen that the driving device 3 used in the present application has a simple structure and low cost, and effectively ensures the driving force for the moving frame 1. Compared with a traditional motor-driving structure, the driving device 3 is lighter and occupies less space, which is convenient for installation on wearable devices.

In another embodiment of the present application (not shown), the driving device 3 comprises a linear cylinder (not shown), and an output end of the linear cylinder is connected to the moving frame 1. The linear cylinder is configured to drive the moving frame 1 to perform linear motion, which can also achieve a stretching massage action on the human fingers.

In other embodiments of the present application (not shown), the driving device 3 can also be a combination of a motor, a gear set, and a connecting rod (not shown), and the motor drives the gear set to drive the connecting rod to drive the moving frame 1 to move, so as to achieve the same technical effect.

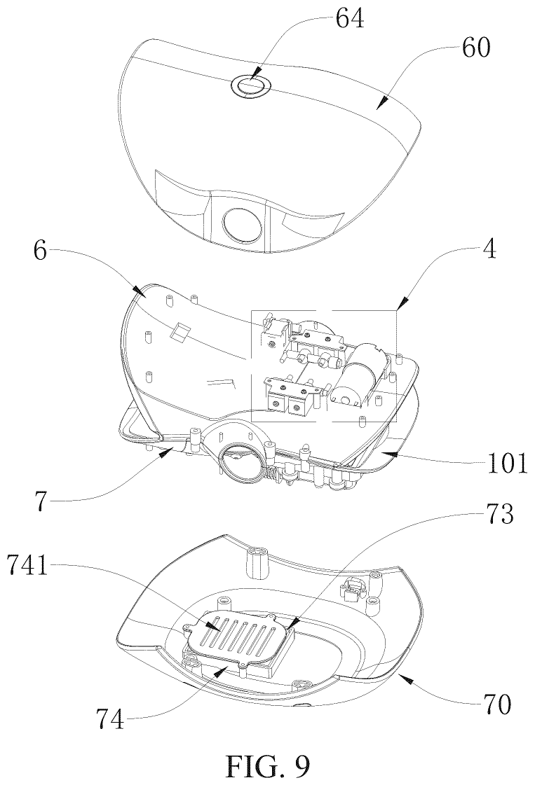

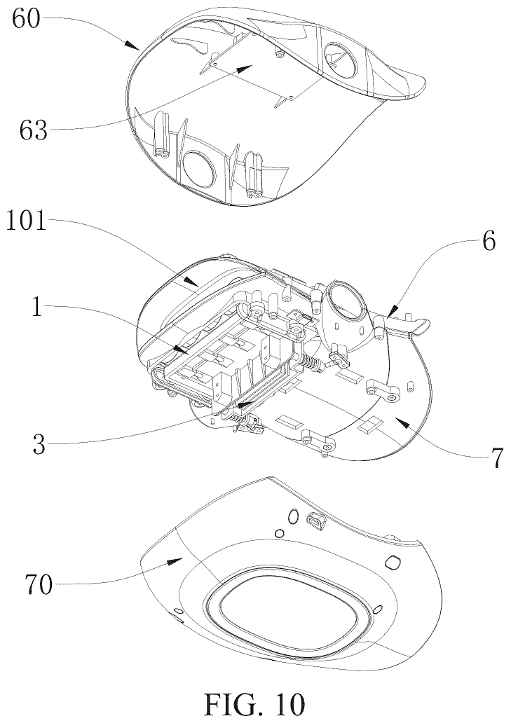

For an overall structure of the hand massaging apparatus provided in the embodiment of the present application, please refer to FIGS. 9 and 10 together. In the embodiment of the present application, the core 100 comprises an upper shell 6 and a lower shell 7, and the upper shell 6 and the lower shell 7 can be assembled with each other. An upper cover 60 and a lower cover 70 configured to be external decorative surfaces are respectively disposed on the upper shell 6 and the lower shell 7, and a wearing channel 101 for the hand of the person to be inserted is provided between the upper shell 6 and the lower shell 7.

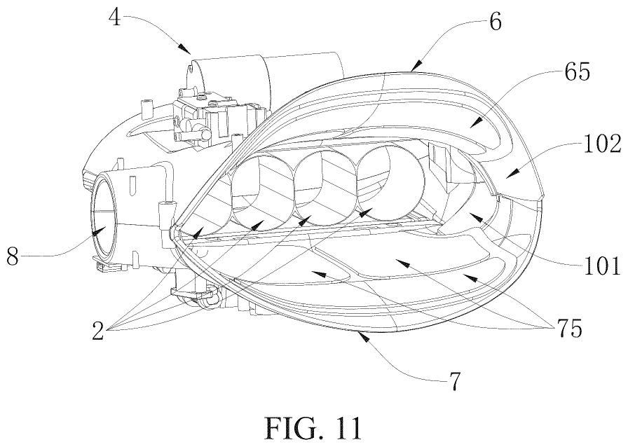

As shown in FIG. 10, the plurality of airbag finger sleeves 2 on the moving frame 1 are disposed adjacent to a first opening of a first end of the wearing channel 101. As shown in FIG. 11, a second opening of a second end of the wearing channel 101 is an entrance 102 for the hand of the person to be inserted. An end of the upper shell 6 located on the entrance 102 is tilted upward, and an end of the lower shell 7 located on the entrance 102 is tilted downward, so that the entrance 102 is expanded from top to bottom. Thus, the hand of the person can be easily inserted into the wearing channel 101, and the human fingers on the hand can be inserted into the plurality of airbag finger sleeves 2.

In this way, a movable assembly comprising the moving frame 1 and the driving device 3 is separated from the inflation assembly 4, and the movable assembly and the inflation assembly 4 are respectively disposed on the upper shell 6 and the lower shell 7, which effectively avoids mutual interference, reasonably arranges the functional mechanisms in the hand massaging apparatus, maximizes the use of an internal space of the hand massaging apparatus, improves a utilization rate of the internal space of the core 100 of the hand massaging apparatus, and is conducive to reducing a volume of a whole machine.

Regarding a layout on the upper shell 6, in this embodiment, please refer to FIG. 5 and FIG. 9. The inflation assembly 4 is disposed on the upper shell 6. The upper shell 6 comprises a buckling socket 61 on which the air pump 41 is installed, so that the air pump 41 can be snap-fastened on the buckling socket 61 for easy disassembly and assembly.

Preferably, the buckling socket 61 comprises a groove 611 for receiving an outlet nozzle of the air pump 41 so as to limit an installation posture of the air pump 41 and thereby prevent mistakes during installation.

As shown in FIG. 5, the upper shell 6 further comprises one or more mounting frames 62 on which the plurality of first air valves 42 are fixed. In this embodiment, the one or more mounting frames 62 are two mounting frames 62 symmetrically disposed on an upper surface of the upper shell 6. Each of the two mounting frames 62 is disposed with two first air valves 42 of the plurality of first air valves 42, and connecting ends of each pair of the plurality of first air valves 42 are arranged facing each other so that the pipelines can be installed on the connecting ends.

Each of the two mounting frames 62 further comprises a series connection pipe 621, and the series connection pipe 621 of each of the two mounting frame 62 is connected to the connection ends of the two first air valves 42. The pipelines connected to the outlet nozzle of the air pump 41 are connected to the series connection pipes 621 of the two mounting frames 62 by a flow divider M, so as to achieve a connection with each of the plurality of first air valves 42.

Preferably, in the embodiment of the present application, a first gap (not shown) is provided between the upper cover 60 and a side of the upper shell 6, and a second gap is provided between the lower cover 70 and a side of the lower shell 7, so that the pipelines can extend from the upper shell 6 to the lower shell 7 through the first gap and the second gap and be respectively connected to the air nozzles of the plurality of airbag finger sleeves 2.

Preferably, in this embodiment, as shown in FIG. 9 and FIG. 10, a control board 63 and a control unit 64 are disposed on the upper cover 60, and the control board 63 is disposed on an inner top wall of the upper cover 60. The control unit 64 is disposed on a surface of the upper cover 60, so that the user can conveniently perform control operations on an upper surface of the hand massaging apparatus. The control unit 64 can preferably adopt physical buttons, touch buttons, or touch screens, etc., which are not specifically limited here.

It can be seen that since the inflation assembly 4 is arranged on the upper shell 6, the air pump 41 and the plurality of first air valves 42 of the inflation assembly 4 are arranged adjacent to the control board 63 on the inner top wall of the upper cover 60, so as to facilitate electrical connection.

Regarding a layout on the lower shell 7, in this embodiment, please refer to FIG. 7 and FIG. 10 together. The moving frame 1 and the driving device 3 are adjacent to each other and are arranged on the lower shell 7, and the plurality of airbag finger sleeves 2 are arranged in the wearing channel 101 for the human fingers of the person to be respectively sleeved. As shown in FIG. 7, the lower shell 7 comprises a receiving opening 71 on which the moving frame 1 is disposed. When the plurality of airbag finger sleeves 2 are in the wearing channel 101 between the upper shell 6 and the lower shell 7, the plurality of airbag finger sleeves 2 pass through the receiving opening 71 and are disposed on the moving frame 1.

The lower shell 7 comprises a surrounding edge 711 arranged around an outer periphery of the receiving opening 71, and fixing rods 72 are respectively provided outside the surrounding edges 711 adjacent to the two sides of the receiving opening 71, so that the position-limiting frames 12 corresponding to the two sides of the moving frame 1 can be installed and fixedly connected to the fixing rods 72. Specifically, the fixing lugs 122 on the position-limiting frames 12 can be installed and fixedly connected to the fixing rods 72 by fasteners, such as screws.

In this embodiment, as shown in FIG. 9, a power supply 73 and a storage box 74 for storing the power supply 73 are provided in the lower cover 70. The storage box 74 is disposed on an inner bottom wall of the lower cover 70. The storage box 74 comprises heat dissipation holes 741. The heat dissipation holes 741 are arranged in a grid shape to improve a heat dissipation effect. In addition, the power supply 73 is arranged at a bottom of a whole machine to play a counterweight role, which is conducive to improving stability of the whole machine when the whole machine is placed on a counter.

In order to enrich a massage function of the hand massaging apparatus, in one embodiment of the present application, referring to FIG. 11, the upper shell 6 is disposed with a first airbag 65 located in the wearing channel 101 and corresponding to a back of the human hand, and the lower shell 7 is disposed with a second airbag 75 located in the wearing channel 101 and corresponding to the palm of the human hand. When the first airbag 65 and the second airbag 75 are inflated, the first airbag 65 and the second airbag 75 can respectively squeeze and massage the back and the palm of the hand of the person inserted into the hand massaging apparatus.

The first airbag 65 and the second airbag 75 can be a single airbag or combination of multiple sub-airbags, as long as volumes of the first airbag 65 and the second airbag 75 can be accommodated in the wearing channel 101 and can cover the back and the palm of the hand of the person, which is not limited herein.

Please refer to FIGS. 5, 8, and 11. The inflation assembly 4 further comprises a third air valve 43 and a fourth air valve 44, which are connected to the air pump 41 through the pipelines. The third air valve 43 is connected to the first airbag 65 through the pipelines, and the fourth air valve 44 is connected to the second airbag 75 through the pipelines, so as to respectively control inflation and deflation of the first airbag 65 and the second airbag 75, so as to start the first airbag 65 and the second airbag 75 separately according to usage requirements.

In this embodiment, as shown in FIG. 5 and FIG. 11, the third air valve 43 is disposed on the upper shell 6, and the first airbag 65 comprises a plurality of first air nozzles. The upper shell 6 comprises a plurality of first through holes 66 corresponding to positions of the plurality of first air nozzles on the first airbag 65, so that each of the plurality of first air nozzles on the first airbag 65 is exposed from a corresponding one of the plurality of first through holes 66 on the upper shell 6. Diverted pipes connected to the plurality of first air nozzles of the first airbag 65 are connected to a main air pipe through the flow divider M, and then are connected to the third air valve 43.

In this embodiment, as shown in FIG. 8 and FIG. 11, the fourth air valve 44 is disposed on the lower shell 7, and the second airbag 75 comprises a plurality of second air nozzles. The lower shell 7 comprises a plurality of second through holes 76. A number of the plurality of second through holes 76 is the same as a number of the plurality of second air nozzles, and the plurality of second through holes 76 correspond to positions of the plurality of second air nozzles, so that the plurality of second air nozzles on the second airbag 75 are exposed from the plurality of second through holes 76 on the lower shell 7. Then, the flow divider M enables the diverted pipes connected to the plurality of second air nozzles to be connected together and then to be connected to the fourth air valve 44 through the main air pipe.

Therefore, the plurality of first air nozzles and the plurality of second ai nozzles are provided on the first airbag 65 and the second airbag 75 to realize synchronous multi-point inflation, thereby effectively increasing inflation speeds of the first airbag 65 and the second airbag 75.

In the embodiments of the present application, referring to FIGS. 1, 5 an 11, two thumb holes 8 for a thumb of the human hand to pass through are respectively provided on two sides of the core 100. The four airbag finger sleeves 2 are provided in the wearing channel 101 between the upper shell 6 and the lower shell 7. When the human hand is inserted into the wearing channel 101 of the hand massaging apparatus, the thumb extends from one of the two thumb holes 8 on the two sides of the core 100, and the index finger, middle finger, ring finger, and little finger are respectively inserted into the four airbag finger sleeves 2 in the wearing channel 101, so that the hand massaging apparatus has a glove-like structure, which is convenient for users to wear and use.

Preferably, in this embodiment, as shown in FIG. 1 and FIG. 5, the two thumb holes 8 on the two sides of the core 100 are symmetrically arranged so that a left hand and a right hand of the person can use the hand massaging apparatus, thereby effectively improving versatility of the hand massaging apparatus.

The embodiment of the present application further provides a new type of the hand massaging apparatus, which can not only realize a massage technique of pressing acupoints, but also stretch massage on the human fingers, effectively enriching massage methods, improving a massage experience, and solving technical problems due to a traditional hand massaging apparatus having only mechanical pressing techniques and a single massage method. It is now described in detail.

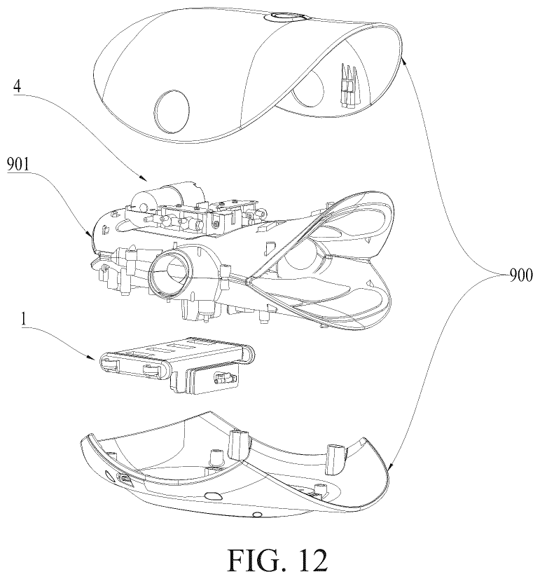

Referring to FIG. 12, the hand massaging apparatus comprises an outer housing 900 and an inner housing 901 fixed inside the outer housing 900, and a receiving space is defined between the outer housing 900 and the inner housing 901. Referring to FIG. 12 to FIG. 17, the hand massaging apparatus at least comprises a moving frame 1, a plurality of airbag finger sleeves 2, a driving device 3, and an inflatable assembly 4.

As for the moving frame 1, the moving frame 1 is reciprocatably arranged on the inner housing 901.

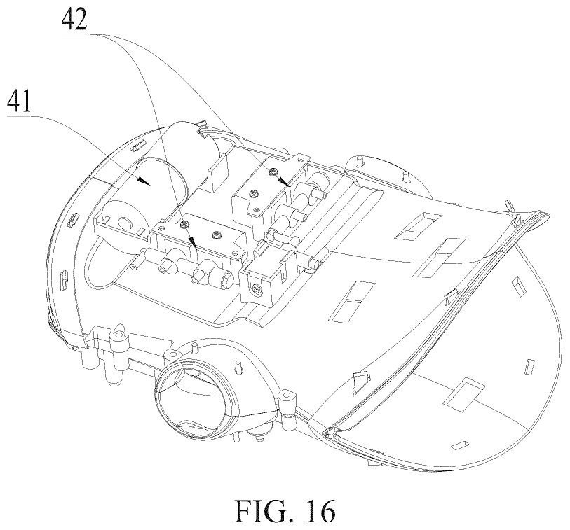

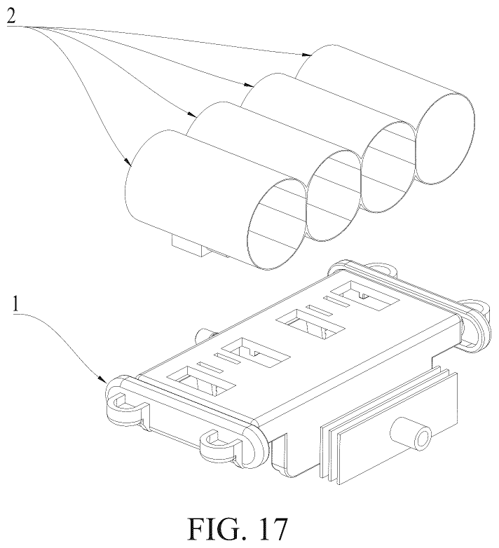

As for the inflation assembly 4 for inflating the plurality of airbag finger sleeves 2, please refer to FIGS. 16 and 17. The inflation assembly 4 comprises an air pump 41 and a plurality of first air valves 42, which are arranged in the receiving space. The plurality of first air valves 42 are connected to the plurality of airbag finger sleeves 2. The air pump 41 is connected to the plurality of first air valves 42 through pipelines, and the plurality of first air valves 42 are connected to the plurality of airbag finger sleeves 2 through pipelines (not shown in the figures). The inflation assembly 4 is configured to respectively control inflation and deflation of the plurality of airbag finger sleeves 2.

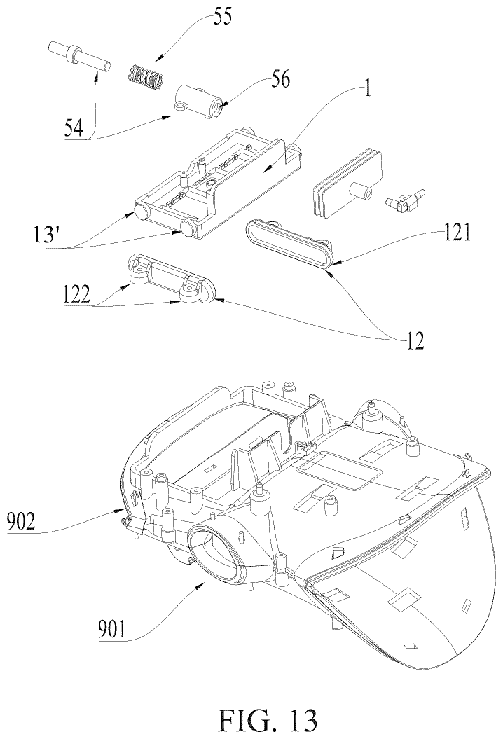

In one embodiment of the present application, referring to FIG. 13, the inner housing 901 comprises a through hole 902, and the moving frame 1 is arranged adjacent to the through hole 902. The plurality of airbag finger sleeves 2 are contained in the inner housing 901, and the plurality of airbag finger sleeves 2 pass through the through hole 902 and are fixedly connected to the moving frame 1. In this way, when the moving frame 1 is driven to move by the driving device 3, the moving frame 1 can drive the plurality of airbag finger sleeves 2 to move synchronously. The inner housing 901 of the hand massaging apparatus further comprises position-limiting frames 12 corresponding to two sides of the moving frame 1, and each of the position-limiting frames 12 has a travel groove 121. Sliding blocks 13′ are respectively disposed on the two sides of the moving frame 1, and the sliding blocks 13′ are configured to be installed and move in the travel grooves 121 of the position-limiting frames 12. The travel grooves 121 and the sliding blocks 13′ are configured to guide the moving frame 1 so that the moving frame 1 moves back and forth along the travel grooves 121, which is conducive to stability of the moving frame 1 during movement and avoids derailment of the moving frame 1. The through hole 902 allows the plurality of airbag finger sleeves 2 to be disposed inside the inner housing 901 while the air pump 41 and the plurality of first air valves 42 can be disposed outside the inner housing 901. In this way, the inflation, deflation, and movement of the plurality of airbag finger sleeves 2 will not affect the air pump 41 and the plurality of first air valves 42, thereby improving safety.

When the driving device 3 drives the moving frame 1 to move, the moving frame 1 moves through the sliding blocks 13′ moving in the travel groove 121 of the position-limit frames 12, thereby limiting a displacement direction and a movement range of the moving frame 1, which is conducive to matching a length of the human fingers and maximizing use of an internal space of the hand massaging apparatus.

In one embodiment of the present application, a cloth sleeve (not shown) is disposed between the plurality of airbag finger sleeves 2 and the inner housing 901. The cloth sleeve is made of a smooth material to reduce a friction between the plurality of airbag finger sleeves 2 and the inner housing 901 during movement, thereby improving smoothness of the plurality of airbag finger sleeves 2 sliding in the inner housing 901 and extending a service life.

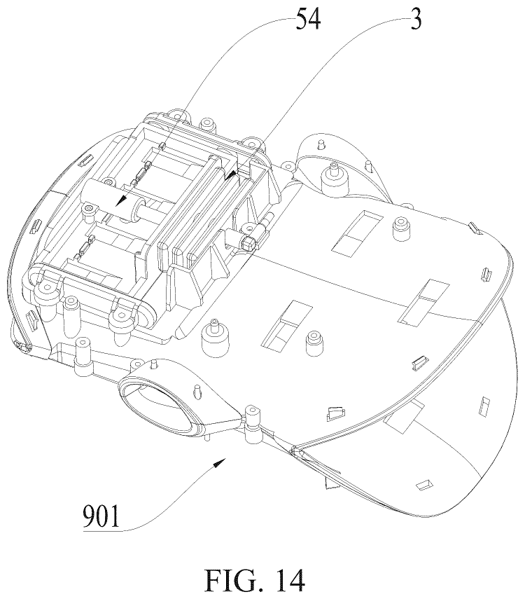

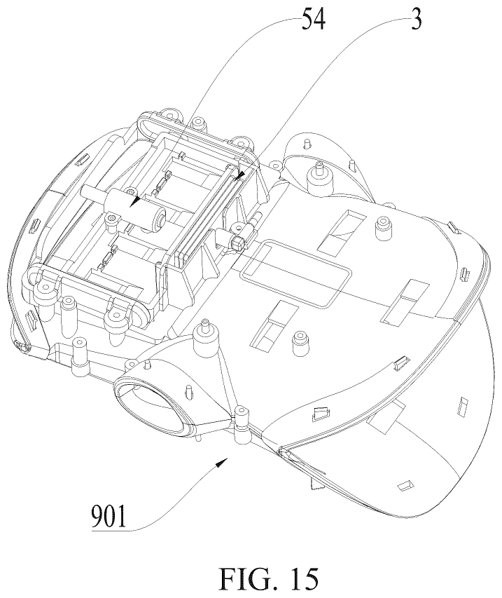

Please refer to FIGS. 13 to 15, wherein FIG. 14 is a diagram of the driving device 3 when inflated, and FIG. 15 is a diagram of the driving device 3 when deflated. In one embodiment, the hand massaging apparatus further includes a guiding rod 54 and a spring 55, and the moving frame 1 comprises a passing through hole 56 corresponding to the guiding rod 54. The spring 55 abuts the guiding rod 54 and the moving frame 1. The driving device 3 is a pushing airbag. When the driving device 3 is deflated, the spring 55 rebounds and pushes the plurality of airbag finger sleeves 2 to move.

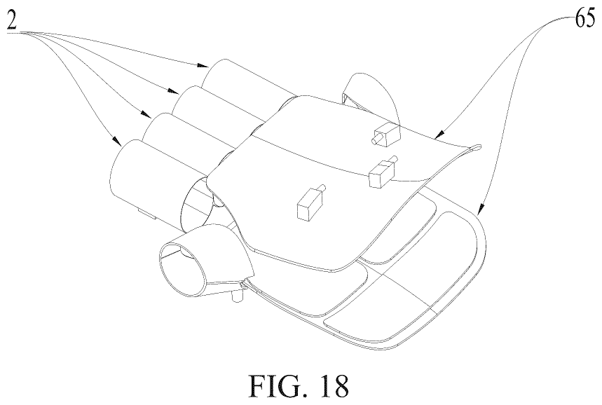

In one embodiment of the present application, referring to FIG. 18, the hand massaging apparatus further comprises a first airbag 65 corresponding to a palm or a back of the human hand. The first airbag 65 is installed on the inner housing 901. When working, the first airbag 65 expands toward a side wall of the inner housing 901 to squeeze the palm or the back of the human hand, so that the palm is fixed in the inner housing 901. At the same time, the plurality of airbag finger sleeves 2 stretch the human fingers along a direction roughly parallel to the side wall of the inner housing 901, thereby forming a massage action similar to an action of human fingers being kneaded and stretched in the extension direction of the human fingers, effectively giving the human fingers a stretching massage feeling.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A hand massaging mechanism, comprising:
a moving frame,
a plurality of airbag finger sleeves disposed on the moving frame and configured to be respectively sleeved on human fingers to be inflated to expand,
a driving device connected to the moving frame and configured to drive the moving frame to move, and
an inflation assembly, wherein:
the inflation assembly comprises an air pump and a plurality of first air valves,
the air pump is connected to each of the plurality of first air valves through pipelines, and
the plurality of first air valves are respectively connected to the plurality of airbag finger sleeves through the pipelines to control inflation and deflation of each of the plurality of airbag finger sleeves.

2. The hand massaging mechanism according to claim 1, wherein:
the moving frame comprises a plurality of fixation holes for receiving the plurality of airbag finger sleeves,
the plurality of fixation holes are arranged in a row on the moving frame, and
air nozzles of the plurality of airbag finger sleeves are respectively exposed from the plurality of fixation holes on the moving frame and are respectively connected to the plurality of first air valves through the pipelines.

3. The hand massaging mechanism according to claim 1, comprising:
position-limiting frames corresponding to two sides of the moving frame, wherein:
each of the position-limiting frames has a travel groove, and
the two sides of the moving frame are respectively disposed with rollers configured to be disposed in the travel grooves and move in the travel grooves.

4. The hand massaging mechanism according to claim 1, comprising:
a mounting base on which the driving device is disposed, wherein:
the driving device is disposed on the mounting base, and
an output end of the driving device is connected to the moving frame.

5. The hand massaging mechanism according to claim 4, wherein:
the mounting base comprises one or more resetting mechanisms for driving the moving frame to automatically reset after displacement,
the mounting base comprises one or more sleeve lugs,
each of the one or more resetting mechanisms comprises a connecting shaft and an elastic member,
a first end of the connecting shaft comprises a position-limiting cap,
a second end of the connecting shaft passes through a corresponding one of the one or more sleeve lugs and is fixedly connected to the moving frame,
the elastic member is sleeved on the connecting shaft, and
two ends of the elastic member are respectively connected to the corresponding one of the one or more sleeve lugs and the position-limiting cap.

6. The hand massaging mechanism according to claim 1, wherein:
the driving device comprises a pushing airbag and a second air valve,
the pushing airbag is configured to expand in a first direction after being inflated,
an expansion end of the pushing airbag is connected to the moving frame, and
the second air valve is connected to the pushing airbag and the air pump through the pipelines.

7. The hand massaging mechanism according to claim 1, wherein:
the driving device comprises a linear cylinder, and
an output end of the linear cylinder is connected to the moving frame.

8. A hand massaging apparatus, comprising:
a core, wherein:
the core comprises the hand massaging mechanism according to claim 1,
the core comprises an upper shell and a lower shell configured to be assembled with each other,
a wearing channel in which a human hand is configured to be disposed is defined between the upper shell and the lower shell,
the inflation assembly is disposed on the upper shell,
the moving frame and the driving device are adjacent to each other and are disposed on the lower shell, and
the plurality of airbag finger sleeves are disposed in the wearing channel and are configured to be respectively sleeved on the human fingers.

9. The hand massaging apparatus according to claim 8, wherein:
the upper shell is disposed with a first airbag located in the wearing channel,
the lower shell is disposed with a second airbag located in the wearing channel,
the inflation assembly comprises a third air valve and a fourth air valve, which are connected to the air pump through the pipelines,
the third air valve is connected to the first airbag through the pipelines, and
the fourth air valve is connected to the second airbag through the pipelines.

10. The hand massaging apparatus according to claim 8, wherein:
thumb holes for a thumb of the human hand to pass through are respectively provided on two sides of the core, and
the thumb holes on the two sides of the core are symmetrically arranged.

11. A hand massaging apparatus, comprising:
an outer housing,
an inner housing,
a moving frame,
a plurality of airbag finger sleeves,
a driving device, and
an inflation assembly, wherein:
the inner housing is fixed inside the outer housing,
a receiving space is defined between the outer housing and the inner housing,
the moving frame is reciprocatably arranged on the inner housing,
the plurality of airbag finger sleeves are configured to be respectively sleeved on human fingers to be inflated to expand,
the driving device is connected to the moving frame and is configured to drive the moving frame to move,
the inflation assembly comprises an air pump and a plurality of first air valves,
the air pump is connected to each of the plurality of first air valves through pipelines,
the plurality of first air valves are respectively connected to the plurality of airbag finger sleeves through the pipelines to control inflation and deflation of each of the plurality of airbag finger sleeves,
the inner housing comprises a through hole,
the moving frame is arranged adjacent to the through hole,
the plurality of airbag finger sleeves are contained in the inner housing,
the plurality of airbag finger sleeves pass through the through hole and are fixedly connected to the moving frame, and
when the plurality of airbag finger sleeves are inflated, the inner housing is configured to confine expansion of the plurality of airbag finger sleeves to apply compressive massage on the human fingers.

12. The hand massaging apparatus according to claim 11, wherein:
the inner housing comprises position-limiting frames corresponding to two sides of the moving frame,
each of the position-limiting frames has a travel groove,
sliding blocks are respectively disposed on the two sides of the moving frame and are configured to be disposed and move in the travel grooves of the position-limiting frames, and
the travel grooves and the sliding blocks are configured to guide the moving frame to move back and forth along the travel grooves.

13. The hand massaging apparatus according to claim 11, wherein:
a cloth sleeve is disposed between the plurality of airbag finger sleeves and the inner housing, and
the cloth sleeve is made of a smooth material to reduce a friction between the plurality of airbag finger sleeves and the inner housing during movement.

14. The hand massaging apparatus according to claim 11, comprising:
a guiding rod, wherein:
the moving frame comprises a passing through hole corresponding to the guiding rod, and
the driving device is a pushing airbag.

15. The hand massaging apparatus according to claim 14, comprising:
a spring, wherein:
the spring abuts the guiding rod and the moving frame, and
when the driving device is deflated, the spring rebounds and pushes the plurality of airbag finger sleeves to move.

16. The hand massaging apparatus according to claim 11, comprising:
a first airbag, wherein:
the first airbag is configured to correspond to a palm or a back of a human hand,
the first airbag is disposed on the inner housing, and
when the hand massaging apparatus is operating:
the first airbag expands toward a side wall of the inner housing to squeeze the palm or the back of the human hand, and
the plurality of airbag finger sleeves stretch the human fingers along a direction substantially parallel to the side wall of the inner housing.
